(19) United States
(12) Patent Application Publication
(10) Pub. No.: US 2012/0169070 A1
(43) Pub. Date: Jul. 5, 2012

(54) SOLENOID-OPERATED ELECTRIC LOCK

(75) Inventor: Chien Ying HUANG, Taichung City (TW)

(73) Assignee: SOCA TECHNOLOGY CO., LTD., TAICHUNG CITY (TW)

(21) Appl. No.: 12/981,520

(22) Filed: Dec. 30, 2010

(51) Int. Cl. E05B 47/02; E05C 1/08

(52) U.S. Cl. 292/142

(57) ABSTRACT

A solenoid-operated electric lock includes a lock casing, a catch movably mounted on the lock casing, and a solenoid received in the lock casing. The solenoid includes a housing, a first magnet and a second magnet respectively mounted on two ends of the housing, and a movable iron core disposed in the housing. A first bolt is disposed on the movable iron core. A wire coil is wound around the movable iron core. The locking casing receives a driving member, a first gearing device, and a second gearing device. The driving member is selectively pressed by the first bolt. The first gearing device is engaged with the driving member and has a rotatable cylinder mounted therein. The second gearing device has a lever selectively abutting against the catch. The lever has an abutting portion formed thereon for releasably connecting with an outer periphery of the rotatable cylinder.

### BACKGROUND OF THE INVENTION

1. Field of the Invention

The present invention relates to an electric lock, and more particularly to the electric lock which is operatable under an external force and has a solenoid disposed therein for saving power.

2. Description of Related Art

A conventional electrically operated door lock includes a latch keeper being rotatable between a first position and a second position. In the first position, the latch keeper obstructs the movement of a door latch. A solenoid has a plunger movable along a linear path between a first position and a second position. An actuator is coupled to the plunger. The actuator is movable along a linear path parallel to the plunger between a first position and a second position. The actuator has a plurality of gear teeth formed thereon. A pinion has a plurality of teeth formed thereon and cooperating with the gear teeth of the actuator. A locking member has a plurality of gear teeth formed thereon and cooperating with the teeth of the pinion. The locking member is movable along a linear path between a first position and a second position. The path is perpendicular to the path of the plunger. As the plunger moves from the first position to the second position urges the locking member to move from the first position to the second position, which urges the latch keeper to move from the first position to the second position.

However, the conventional electrically operated door lock does not have a power saving function, because it requires to be provided continuous electric current for keeping in an unlocked position. And as the door is impacted by a wind force, the door lock is hard to be operated due to the mechanical design. Therefore, the conventional electrically operated door lock described above is inconveniently used.

The present invention has arisen to mitigate and/or obviate the disadvantages of the conventional electrically operated door lock.

### SUMMARY OF THE INVENTION

The main objective of the present invention is to provide an improved solenoid-operated electric lock.

To achieve the objective, the solenoid-operated electric lock in accordance with the present invention comprises a lock casing, a catch movably mounted on the lock casing, and a solenoid received in the lock casing. A circuit means is received in the lock casing and is electrically connected with the solenoid for controlling duration of electric current and switching a direction of electric current which is applied to the solenoid.

The solenoid comprises a housing, a first magnet and a second magnet respectively mounted on two ends of the housing. The first magnet and the second magnet are arranged in a NN or SS relationship to repel each other. A movable iron core is axially disposed in the housing and located between the first and second magnets. One end of the movable iron core has a first bolt axially disposed thereon for simultaneously moving with the movable iron core. The first bolt is partially exposed the outside of the solenoid. A wire coil is coaxially received in the housing. The wire coil is wound around the movable iron core and located between the first and second magnets.

The solenoid-operated electric lock further comprises a driving member, a first gearing device, and a second gearing device movably received in the lock casing. The driving member corresponds to a location of the first bolt of the solenoid and is selectively pressed by the first bolt. The driving member has an engaging hole defined therein. The first gearing device has a pivot member pivotally connected with the lock casing and a rotatable cylinder rotatably mounted on the pivot member. The pivot member has a pin disposed thereon for engaging with the driving member, such that the first gearing device is able to be simultaneously driven by the driving member. The second gearing device has a lever pivotally mounted on the lock casing. The lever has an abutting portion formed thereon for releasably connecting with an outer periphery of the rotatable cylinder. The lever has a protrusion formed thereon and located adjacent to the catch for selectively abutting against the catch. The second gearing device has a spring disposed beside the lever. The spring provides a resilient force to the lever to bias the lever toward the catch.

When the circuit means provides electric current in a short time to actuate the solenoid, a magnetic field is generated around the wire coil and the movable iron core forms two opposing magnetic poles. The movable iron core is axially moved toward the first magnet by magnetic attraction. The first bolt is axially moved with the movable iron core to press the driving member away from the solenoid. The pivot member of the first gearing device simultaneously and pivotally moves by the movement of the driving member. The abutting portion of the lever of the second gearing device is released from the rotatable cylinder, such that the catch is in an unlock position.

When the solenoid is actuated again by providing reverse electric current in a short time to generate a reverse magnetic field around the wire coil, the movable iron core is axially moved away the first magnet by magnetic repulsion. The driving member axially moves toward the solenoid and the first gearing device is driven to restore. The abutting portion of the lever is restricted by the rotatable cylinder. The protrusion of the lever abuts against the catch, such that the catch is in a lock position.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a solenoid-operated electric lock in accordance with the present invention;

FIG. 2 is a perspective view of the solenoid-operated electric lock in accordance with the present invention cooperating with a latch of a door;

FIG. 3 is a cross-sectional assembled view of the solenoid-operated electric lock in accordance with the present invention;

FIG. 4 is a partially assembled perspective view of the solenoid-operated electric lock in accordance with the present invention;

FIG. 5 is a cross-sectional view of a solenoid of the solenoid-operated electric lock in accordance with the present invention;

FIG. 6 is a cross-sectional view of the solenoid of the solenoid-operated electric lock in accordance with the present invention as a movable iron core moves toward a first magnet;

FIG. 6A is a schematic circuit view in accordance with FIG. 6;

FIG. 7 is a cross-sectional view of the solenoid of the solenoid-operated electric lock in accordance with the present invention as the movable iron core moves away form the first magnet;

FIG. 7A is a schematic circuit view in accordance with FIG. 7; and

FIGS. 8-10 are cross-sectional operational views of a lever and a rotatable cylinder of the solenoid-operated electric lock in accordance with the present invention.

### DETAILED DESCRIPTION OF THE INVENTION

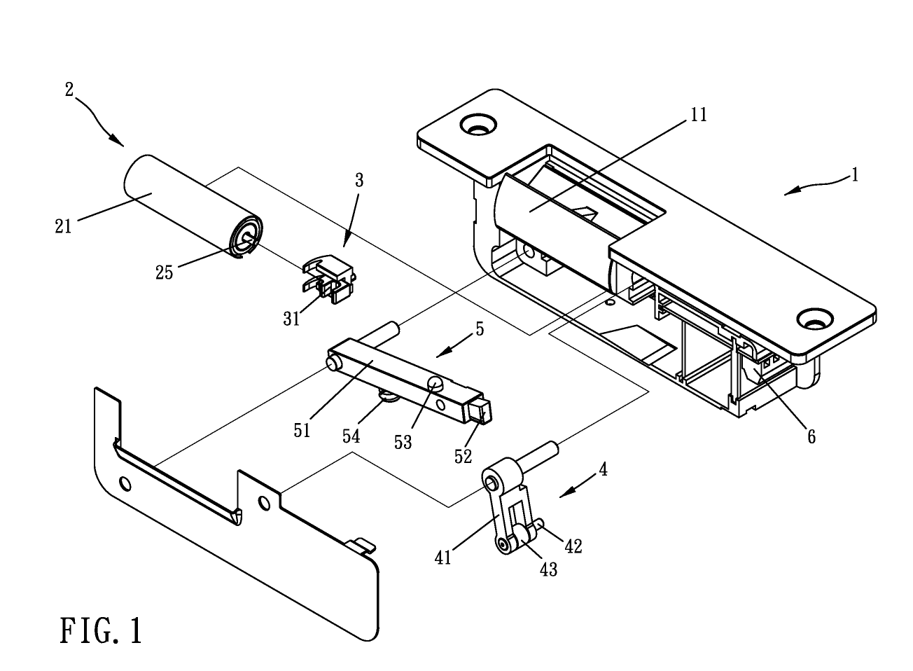

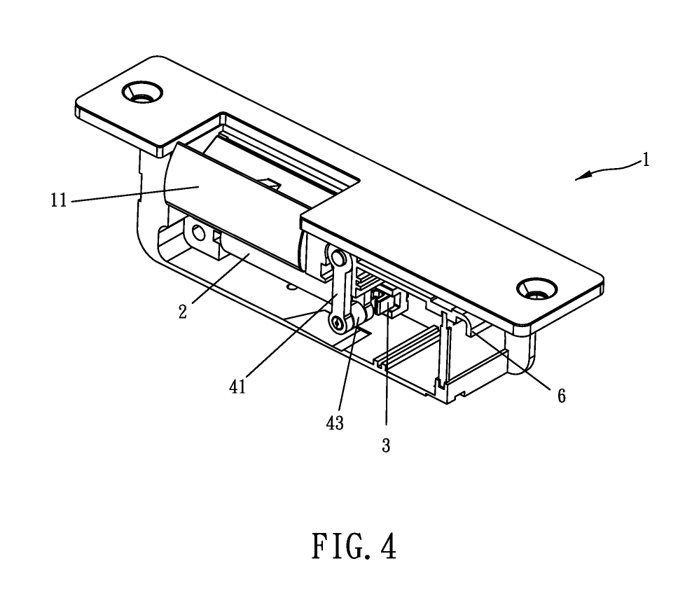

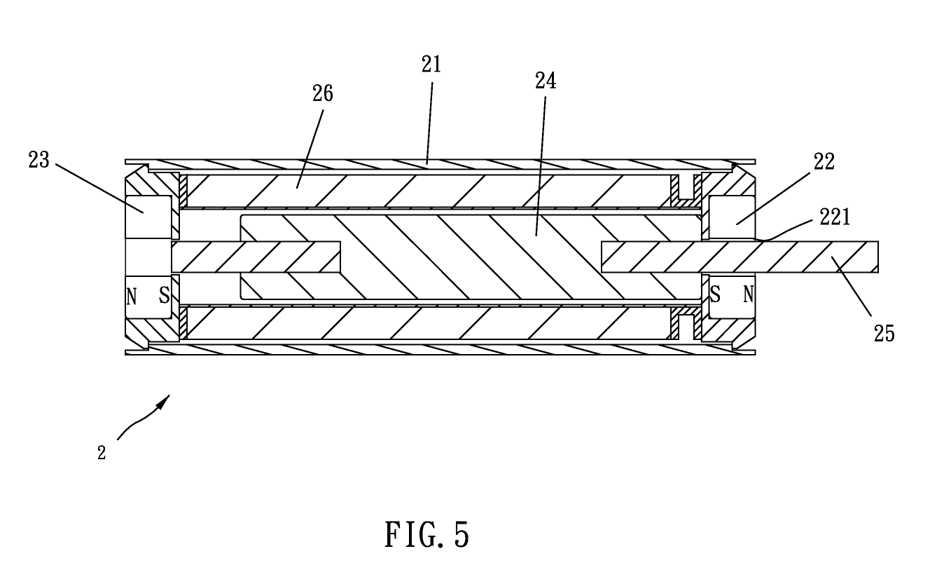

Referring to the drawings and initially to FIGS. 1-5, a solenoid-operated electric lock in accordance with a preferred embodiment of the present invention comprises a lock casing 1 which is mounted on a door frame 7, a catch 11 movably mounted on the lock casing 1 for selectively engaging with a latch 81 of a door 8, and a solenoid 2 received in the lock casing 1. A circuit means 6 is received in the lock casing 1 and is electrically connected with the solenoid 2 for controlling duration of electric current and switching directions of electric current which is applied to the solenoid 2.

The solenoid 2 comprises a housing 21, a first magnet 22 and a second magnet 23 respectively mounted on two ends of the housing 21. The first magnet 22 has a through hole 221 axially defined therein. In this embodiment, the first magnet 22 and the second magnet 23 are arranged in a SS relationship to repel each other. A movable iron core 24 is axially disposed in the housing 21 and located between the first 22 and second magnets 23. One end of the movable iron core 24 has a first bolt 25 axially disposed thereon for simultaneously moving with the movable iron core 24. The first bolt 25 has a free end passing through the through hole 221 of the first magnet 22 and partially exposed the outside of the solenoid 2. A wire coil 26 is coaxially received in the housing 21. The wire coil 26 is located between the first 22 and second magnets 23 and wound around the movable iron core 24. The wire coil 26 is electrically connected with the circuit means 6, such that the circuit means 6 controls electric current which is applied into the wire coil 26.

The solenoid-operated electric lock further comprises a driving member 3, a first gearing device 4, and a second gearing device 5 movably received in the lock casing 1. The driving member 3 corresponds to a location of the first bolt 25 of the solenoid 2 and is selectively pressed by the first bolt 25. The driving member 3 has an engaging hole 31 defined therein.

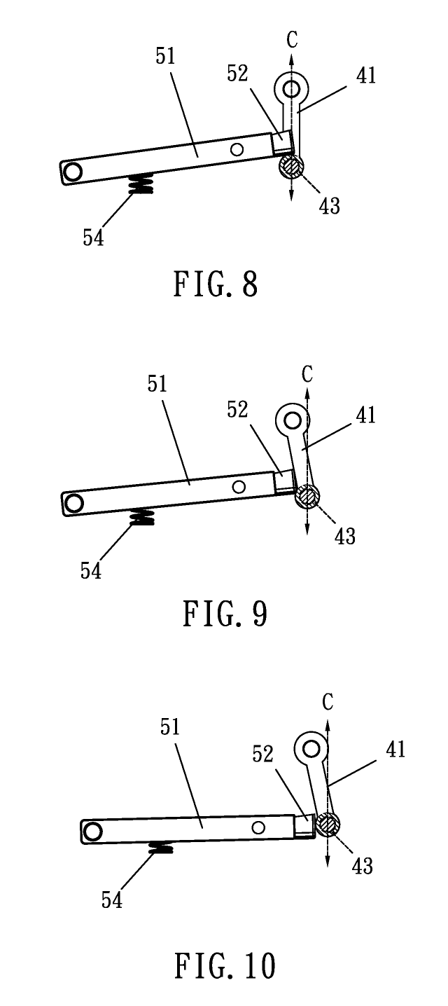

The first gearing device 4 has a pivot member 41 which has one end pivotally connected with the lock casing 1 for rotating about a pivot axis. The other end of the pivot member 41 has a rotatable cylinder 43 mounted thereon for rotating relative to the pivot member 41 about a center axis. The pivot axis of the pivot member 41 is parallel to the center axis of the rotatable cylinder 43. The rotatable cylinder 43 has a C-axis perpendicular to the center axis and the pivot axis (shown in FIG. 8-10). The pivot member 41 has a pin 42 laterally disposed thereon for engaging with the engaging hole 31 of the driving member 3, such that the first gearing device 4 is able to be simultaneously driven by the driving member 3.

The second gearing device 5 has a lever 51 which has one end pivotally mounted on the lock casing 1. The other end of the lever 51 has an abutting portion 52 formed thereon and downwardly abutting against an outer periphery of the rotatable cylinder 43 for releasably engaging with the rotatable cylinder 43. Referring to FIG. 8-10, as the abutting portion 52 is in an engaging position along the C-axis of the rotatable cylinder 43, the abutting portion 52 of the lever 51 is engagedly restricted by the rotatable cylinder 43. As the abutting portion 52 is moved away from the engaging position, the lever 51 is pivotally movable. The lever 51 has a protrusion 53 formed thereon and corresponding to a location of the catch 11 for selectively abutting against the catch 11. The second gearing device 5 has a spring 54 disposed beside the lever 51 and providing a resilient force to the lever 51 for biasing the lever 51 toward the catch 11.

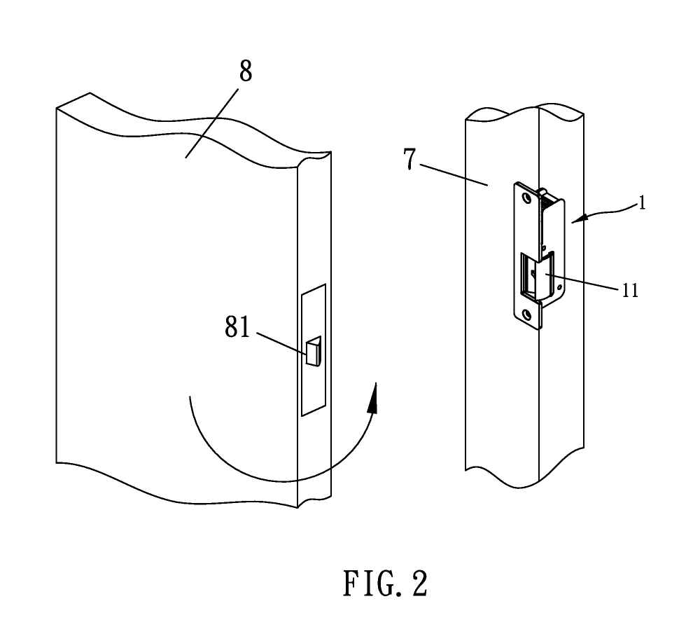

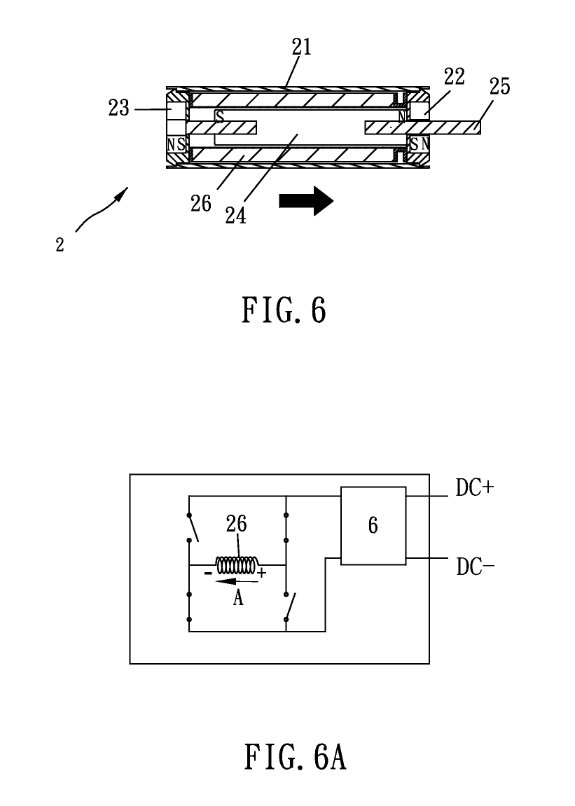

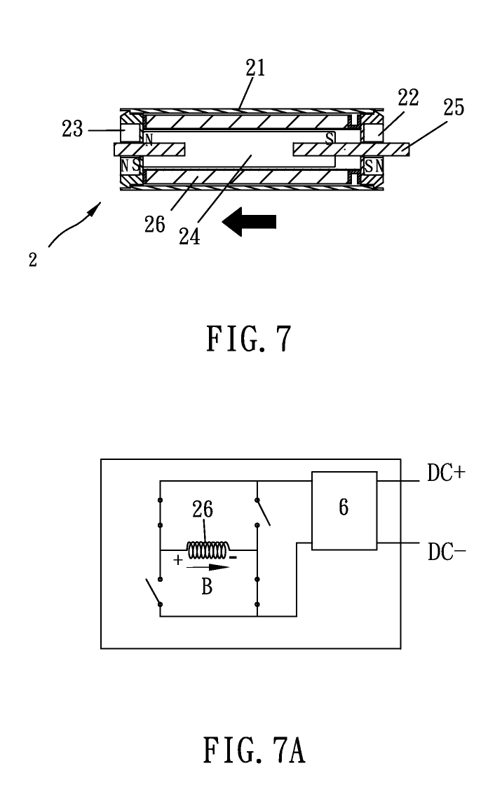

The operation of the solenoid-operated electric lock in accordance with the present invention will be described in detailed below. As shown in FIGS. 6-10, when electric current controlled by the circuit means 6 flows into the wire coil 26 of the solenoid 2 in a direction of arrow A in a short period of time, the solenoid 2 is actuated to generate a magnetic field around the wire coil 26. The movable iron core 24 correspondingly forms a N magnetic pole at one end which is close to the first magnet 22 and a S magnetic pole at the other end which is close to the second magnet 23. The movable iron core 24 is axially moved toward the first magnet 22 by magnetic attraction. The first bolt 25 is axially moved with the movable iron core 24 to press the driving member 3 away from the solenoid 2. The pivot member 41 simultaneously and pivotally rotates about the pivot axis by the movement of the driving member 3. The abutting portion 52 of the lever 51 is relatively moved away from the engaging position. The abutting portion 52 of the lever 51 is released from the rotatable cylinder 43, such that the catch 11 is in an unlock position and the door 8 (shown in FIG. 2) is openable.

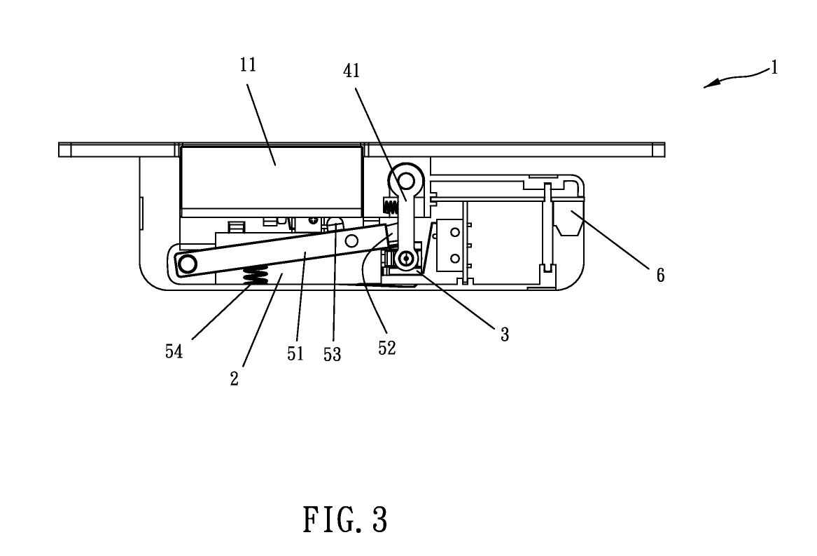

When electric current controlled by the circuit means 6 flows into the wire coil 26 in a direction of arrow B opposite to arrow A in a short period of time, the solenoid 2 is actuated again to generate a reverse magnetic field around the wire coil 26. The movable iron core 24 correspondingly forms a S magnetic pole at one end which is close to the first magnet 22 and a N magnetic pole at the other end which is close to the second magnet 23. The movable iron core 24 is axially moved away the first magnet 22 by magnetic repulsion. The driving member 3 axially moves toward the solenoid 2 and the first gearing device 4 (shown in FIG. 1, 3-4) is driven to restore. The abutting portion 52 of the lever 51 is relatively moved back to the engaging position and is restricted by the rotatable cylinder 43. The protrusion 53 of the lever 51 abuts against the catch 11 (shown in FIG. 3), such that the catch 11 is in a lock position and securely fastened to the latch 81 of the door 8 (shown in FIG. 2).

Moreover, electric current is supplied in the short period of time when the catch 11 changes to the lock position from the unlock position or to the unlock position from the lock position. Therefore, the solenoid-operated electric lock in accordance with the present invention is power saving. And due to the two magnets 22, 23 applied in the solenoid 2, the solenoid 2 in accordance with the present invention is able to generate a sufficient force which is substantially greater than three times a force of a conventional solenoid. Furthermore, as the catch 11 is in the lock position and a strong external force is applied on the door 8, the latch 81 may force the catch 11 to abut against the lever 51. The abutting portion 52 would press on the outer periphery of the rotatable cylinder 43. Because the rotatable cylinder 43 which is pressed is rollable relative to the lever 51 and the pivot member 41, the pivot member 41 is pivotally movable by the movement of the driving member 3. Therefore, the solenoid-operated electric lock is operatable as the strong external force is applied on the door 8.

Although the invention has been explained in relation to its preferred embodiment, it is to be understood that many other possible modifications and variations can be made without departing from the spirit and scope of the invention as hereinafter claimed.

What is claimed is:

1. A solenoid-operated electric lock comprising:
a lock casing, a catch movably mounted on the lock casing;
a solenoid received in the lock casing, the solenoid comprising:
a housing;
a first magnet and a second magnet respectively mounted on two ends of the housing;
a movable iron core axially disposed in the housing and located between the first and second magnets, one end of the movable iron core having a first bolt axially disposed thereon for simultaneously moving with the movable iron core, the first bolt partially exposed the outside of the solenoid; and
a wire coil coaxially received in the housing, the wire coil wound around the movable iron core and located between the first and second magnets;
wherein when the solenoid is actuated by providing electric current in a short period of time to generate a magnetic field around the wire coil, the movable iron core axially moved toward the first magnet by magnetic attraction; when the solenoid is actuated again by providing reverse electric current to generate a reverse magnetic field around the wire coil, the movable iron core axially moved away the first magnet by magnetic repulsion;
a driving member movably received in the lock casing, the driving member selectively pressed by the first bolt of the solenoid;
a first gearing device pivotally received in the lock casing, the first gearing device engaged with the driving member so as to be driven by the driving member, the first gearing device having a rotatable cylinder rotatably mounted therein; and
a second gearing device received in the lock casing, the second gearing device having a lever pivotally mounted on the lock casing for selectively abutting against the catch, the lever having an abutting portion formed thereon and abutting against an outer periphery of the rotatable cylinder for releasably engaging with the rotatable cylinder;
whereby when the first bolt is axially moved with the movable iron core to press the driving member away from the solenoid, the first gearing device simultaneously and pivotally moves by the movement of the driving member, the abutting portion of the lever of the second gearing device released from the rotatable cylinder, such that the catch is in an unlock position; when the driving member axially moves toward the solenoid and the first gearing device is driven to restore, the abutting portion of the lever of the second gearing device is restricted by the rotatable cylinder, the lever abutting against the catch, such that the catch is in a lock position.

2. The solenoid-operated electric lock as claimed in claim 1 further comprising a circuit means electrically connected with the solenoid for controlling duration of electric current and switching the direction of electric current applied to the solenoid.

3. The solenoid-operated electric lock as claimed in claim 1, wherein the first magnet and the second magnet are arranged in a NN/SS relationship to repel each other.

4. The solenoid-operated electric lock as claimed in claim 1, wherein the first gearing device has a pivot member pivotally connected with the lock casing, the pivot member having a pin disposed thereon, the driving member having an engaging hole defined therein for engaging with the pin, such that the driving member is able to simultaneously drive the first gearing device.

5. The solenoid-operated electric lock as claimed in claim 1, wherein the lever has a protrusion formed thereon and located adjacent to the catch for selectively abutting against the catch, the second gearing device having a spring disposed beside the lever for providing a resilient force to the lever.
